(19) United States
(12) Patent Application Publication
(10) Pub. No.: US 2025/0175245 A1
(43) Pub. Date: May 29, 2025

(54) DEVICE RECOVERY BASED ON OPERATIONAL TRUST

(71) Applicant: Hughes Network Systems, LLC, Germantown, MD (US)

(72) Inventors: Shanti Swarup Vedula, Boyds, MD (US); Patrick J. O'Neil, Montgomery Village, MD (US)

(21) Appl. No.: 18/961,578

(22) Filed: Nov. 27, 2024

Related U.S. Application Data
(60) Provisional application No. 63/603,740, filed on Nov. 29, 2023.

(51) Int. Cl. H04B 7/185; H04L 41/082

(52) U.S. Cl. CPC H04B 7/18519; H04L 41/082

(57) ABSTRACT

Methods, systems, and apparatus, including computer programs encoded on computer-storage media, for operational trust-based device auto-recovery. In some implementations, a device operates using first configuration information stored by the device. The device receives updated configuration information and stores the updated configuration information while maintaining storage of the first configuration information. The device sets itself to operate with the updated configuration information subject to a limitation, and the device is configured to revert to using the first configuration information if one or more predetermined conditions occur. The communication device then operates using the updated configuration information subject to the limitation.

### CROSS-REFERENCE TO RELATED APPLICATIONS

This application claims the benefit of priority to U.S. Provisional Patent Application No. 63/603,740, filed on Nov. 29, 2023, the entire contents of which is incorporated by reference herein.

### BACKGROUND

The present specification relates to software and configuration management of devices, such as communication devices.

In many cases, after a communication device is sold, the manufacturer provides updates to the software or configuration settings of the device. For example, a device may download an update over the Internet and apply the update to improve security, add features, increase compatibility, and so on.

### SUMMARY

In some implementations, a device is configured to receive and apply updates in a manner that the device can automatically recover if the update introduces incompatibility or otherwise impairs the function of the device. When updating the software, firmware, or settings of a device, there is a possibility that the updated device may not operate as intended. For example, it is possible that the update includes a flaw or that the update does not operate well with other settings of the device. To ensure that a device will operate reliably after updates, the device can be configured to store multiple copies of its configuration information (e.g., software, firmware, settings, etc.). When new configuration information is received, the new configuration information is placed in its own storage area or partition, so it does not overwrite the previous configuration information that was known to operate correctly. The device can set itself to use the new configuration information but with a limitation. For example, the device can set a low trust level that allows the new configuration information to be used once for booting or starting the device. The device is configured so that when it does start using the new configuration information, it tests its operation to verify proper operation. For a communication device, that testing can involve communicating with a remote system (e.g., a server system of the device manufacturer or an administrator) to verify that the communication features operate as intended. If the device confirms that it operates properly with the new configuration information, then it can raise the trust level for the new configuration information and continue to use that configuration in general use going forward. If the device does not confirm that it is operating properly, the device automatically reverts to the previous configuration (e.g., the last known good configuration).

This process can be nearly transparent to the user. If the update is successful, the device switches to using the new configuration information and the device operates as intended. If an update is unsuccessful, and the device cannot confirm proper operation of the device (e.g., cannot communicate with a remote server to obtain confirmation), then the unsuccessful update can be discarded or no longer used as soon as the user reboots or power cycles the device and the device reverts to the previous, properly-operating configuration.

Many devices, including managed embedded devices such as satellite terminals, routers, gateways, Internet-of-things (IOT) devices, etc., maintain two versions of software and configuration data, for example, a “factory” version loaded initially when shipped from the factory, and a “main” version that is the most recent and fully-featured (e.g., with new features and bug fixes downloaded from the network). Typically, if the user needs to restore operation and revert to the factory version (e.g., in order to recover the device from an error state), the user presses a “rescue” button or “reset” button at the back of the device or through a locally executed command. To preserve the ability to restore or revert the device to the factory settings, the factory version is often left untouched, e.g., not updated unless absolutely required.

In many cases, devices may be located in remote areas, so it becomes very important to make sure only compatible software is downloaded and installed, and also provide a recovery mechanism in the event that an upgrade fails. Many different types of failures can impact the update process, such as data corruption, power interruption during the upgrade process, and upgrades that prevent the device from becoming operational.

Software updates can include updates to a board support package (e.g., Linux kernel with root file system and device tree binaries), potentially across multiple storage partitions or mounts. For some devices, software and configuration data can be provided for several components of a device. For example, in addition to the main operating software and/or firmware for a device, there may be separate software, firmware, and/or configuration settings for a radio subsystem, an antenna, a modem, a storage subsystem, a display device, an input device, etc. In these cases, a software “bundle” having a software package for each component, along with the corresponding configuration settings, is qualified together to make sure the components function correctly and are compatible with each other. The software bundle can be provided as a partition in the file system, and can include a complete set of software and configuration settings for the device. As a result, different partitions can store different complete sets of software and configuration data for running the device. In this case, it typically would not cause any issues for the device to switch from running the software in one partition to running the software in another partition (e.g., switching from using the current main partition to the factory partition) because each partition is self-contained with a full set of the software and configuration needed to run the device.

In some cases, over a long period of time, the factory version may become too old and out-of-date compared to the latest software. As a result, switching to the factory partition may potentially cause some issues, especially if protocols have changed or firmware of components has changed. For example, a mismatch in configuration can occur, in which the older software does not recognize some newer advanced configuration parameters. As another example, security loopholes might occur, where a password change in the main partition may not carry over to the factory partition. As another example, switching to an older version of component software might cause some issues, such as if software that interacts with a modem (e.g., applications, workflows, etc.) is no longer compatible with the older version of the modem component software in the factory partition. As a result, the system can enable a device to update the “factory” version of software and configuration settings, but in a reliable way. The factory version serves an important purpose as the fallback version or restore version in case of device malfunction, so the device does not replace the factory version unless appropriate conditions are met. This can include various tests or requirements, such as achieving successful communication results (e.g., confirmation with communication with a remote server), successful operation for a predetermined number of boots or amount of operation time, a desired level of performance, and so on. The provider of the updates can also designate which updates are qualified or certified as replacements of the factory version and can specify when a significant enough change has been made to cause an update to the factory version to become appropriate.

The techniques discussed herein provide an “operational trust” based system and mechanism to (1) reliably recover from operational failures due to newly installed software, and (2) reliably upgrade the outdated factory version in the field. As discussed further below, these techniques can use levels of trust assigned to software and configuration settings to allow new software versions to be used and monitored by a device, and to be kept only if they satisfy predetermined standards of operation. For example, an updated software version can be automatically discarded by a device if it is executed but does not allow the device to achieve connectivity in a network or perform other operations successfully. Similarly, factory versions can be upgraded only after appropriate conditions are satisfied, such a version designated as a new factory version operating successfully for at least a minimum predetermined amount of time, number of device restarts, etc. These techniques help ensure that a device can be safely updated and that errors or incompatibilities from an update do not impair device operation for the user.

In one general aspect, a method performed by a communication device includes: while operating the communication device using first configuration information stored by the communication device, receiving, by the communication device, updated configuration information; storing, by the communication device, the updated configuration information while maintaining storage of the first configuration information; setting, by the communication device, the communication device to operate with the updated configuration information subject to a limitation, where the communication device is configured to revert to using the first configuration information instead of the updated configuration information upon occurrence of one or more predetermined conditions; and after setting the communication device to operate with the updated configuration information subject to the limitation, operating the communication device using the updated configuration information subject to the limitation.

In some implementations, the updated configuration information includes at least one of updated software, updated firmware, or updated configuration settings.

In some implementations, the method includes, after operating the communication device using the updated configuration information subject to the limitation, reverting to operating the communication device using the first configuration information in response to an occurrence of one or more predetermined conditions.

In some implementations, the communication device is configured to revert to using the first configuration information after a power cycle or restart unless the communication device achieves communication with a remote system that confirms that the communication device operates properly using the updated configuration information.

In some implementations, the limitation includes a limitation on a number of times the communication device loads the updated configuration information or boots using the updated configuration information.

In some implementations, setting, by the communication device, the communication device to operate with the updated configuration information subject to the limitation includes setting a temporary or partial level of trust for the updated configuration information that limits the updated configuration information to be loaded or booted only once without further verification based on information from a remote system over a communication network.

In some implementations, setting the communication device to operate with the updated configuration information includes (i) setting a boot variable to specify that updated configuration settings are to be loaded or booted at a next restart or power cycle of the communication device and (ii) specifying a trust status that indicates that the updated configuration settings are used temporarily. The method includes: after setting the boot variable: restarting the communication device to load the updated configuration settings or boot the communication device with the updated configuration settings; and based on the trust status that indicates that the updated configuration settings are used temporarily, (i) setting the boot variable to specify that the first configuration settings are to be loaded or booted at a next restart or power cycle of the communication device, and (ii) altering the trust status such that the updated configuration settings are no longer used.

In some implementations, setting the communication device to operate with the updated configuration information subject to the limitation includes designating the updated configuration information to be temporary or untrusted, and adjusting boot settings of the communication device to permit only a single boot of the communication device using the updated configuration information that is temporary or untrusted.

In some implementations, when operating the communication device with the updated configuration information subject to the limitation, the communication device is configured to revert to the first configuration information after power loss or restart if the communication device, using the updated configuration information, does not obtain a confirmation from a remote computer system over a communication network.

In some implementations, the first configuration information includes a factory-installed version of at least one of software, firmware, or configuration settings for the communication device.

In some implementations, the first configuration information includes a previous version of at least one of software, firmware, or configuration settings at least partially received over a communication network.

In some implementations, when operating the communication device with the updated configuration information subject to the limitation, the communication device is configured to discontinue using the updated configuration information in response to an occurrence of one or more predetermined conditions before receiving a confirmation over a communication network.

In some implementations, the one or more predetermined conditions comprise at least one of power loss, restarting the communication device, or rebooting the communication device.

In some implementations, the method includes verifying that a checksum and/or signature for the updated configuration information is valid. Setting the communication device to operate with the updated configuration information subject to a limitation is based on verifying that the checksum and/or signature for the updated configuration information is valid.

In some implementations, the first configuration information is stored in a first storage partition and the updated configuration information is stored in a second storage partition. Setting the communication device to operate with the updated configuration information subject to the limitation includes: adjusting boot settings of the communication device to perform the next boot from the second storage partition that includes the updated configuration information; and setting a level of trust that specifies that the second storage partition is to be used temporarily. The method includes: rebooting the communication device to cause the communication device to boot using the second storage partition that includes the updated configuration information; and after rebooting the communication device, adjusting the boot settings of the communication device to perform subsequent boots using the first storage partition that includes the first configuration information and to no longer boot using the second storage partition that includes the updated configuration information.

In some implementations, while operating the communication device using the updated configuration information, obtaining, by the communication device, confirmation for the updated configuration information through communication of the communication device with a remote computer system over a communication network; and setting, by the communication device, the communication device to use the updated configuration information without the limitation.

In some implementations, the limitation involves, after operating using the updated configuration information, limiting or blocking the use of the updated configuration information after power loss, reboot, or restart of the communication device. Setting the communication device to use the updated configuration information without the limitation includes setting the communication device to use the updated configuration information without the limiting or blocking of use of the updated configuration information, including after power loss, reboot, or restart.

In some implementations, the communication device is a satellite terminal or a satellite gateway.

In some implementations, the communication device is configured to store multiple versions of configuration information in different partitions, including by storing (i) a factory version of the configuration information in a first partition and (ii) an updated version of the configuration information in a second partition. Receiving the updated configuration information includes receiving an update that is qualified as an updated factory version of the configuration information. The method includes, after operating the communication device using the updated factory version of the configuration information in a manner that satisfies a set of predetermined criteria, replacing the factory version of the configuration in the first partition with the updated factory version of the configuration information.

Other embodiments of these aspects include corresponding systems, apparatus, and computer programs, configured to perform the actions of the methods, encoded on computer storage devices. A system of one or more computers can be so configured by virtue of software, firmware, hardware, or a combination of them installed on the system that in operation cause the system to perform the actions. One or more computer programs can be so configured by virtue having instructions that, when executed by data processing apparatus, cause the apparatus to perform the actions.

The details of one or more embodiments of the invention are set forth in the accompanying drawings and the description below. Other features and advantages of the invention will become apparent from the description, the drawings, and the claims.

### BRIEF DESCRIPTION OF THE DRAWINGS

FIGS. 1A-1D are diagrams showing examples of a system for updating software and configuration of a device.

FIG. 2 is a state diagram showing state transitions based on levels of trust of a main software version.

FIG. 3 is a diagram showing an example of a device storage partitions layout for managing software and configurations of a device.

Like reference numbers and designations in the various drawings indicate like elements.

### DETAILED DESCRIPTION

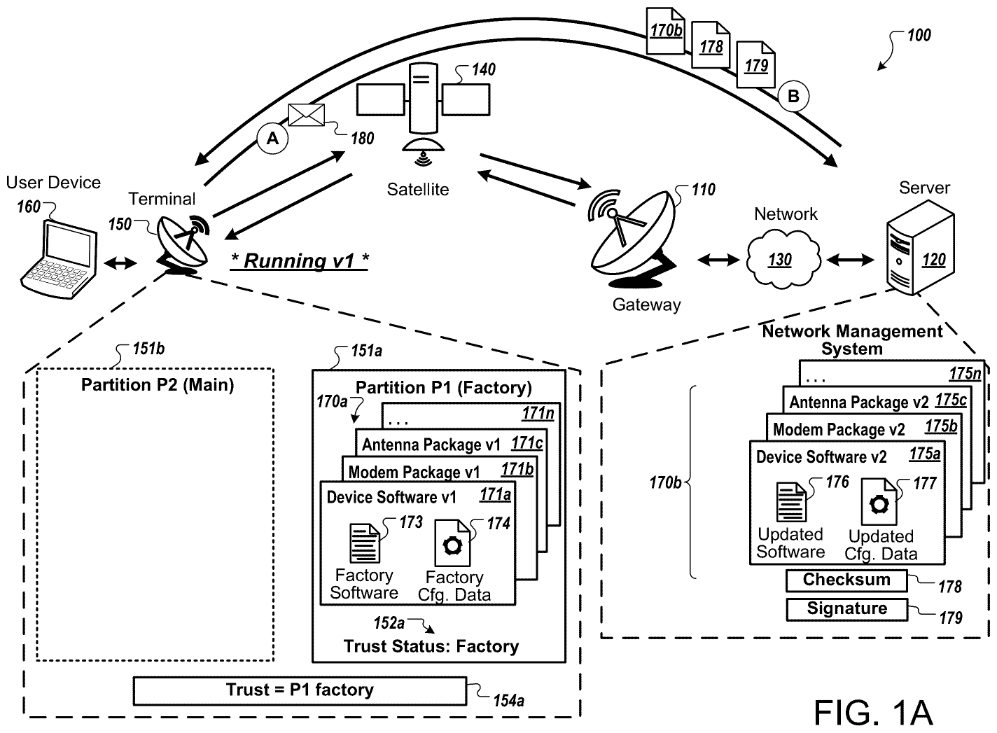

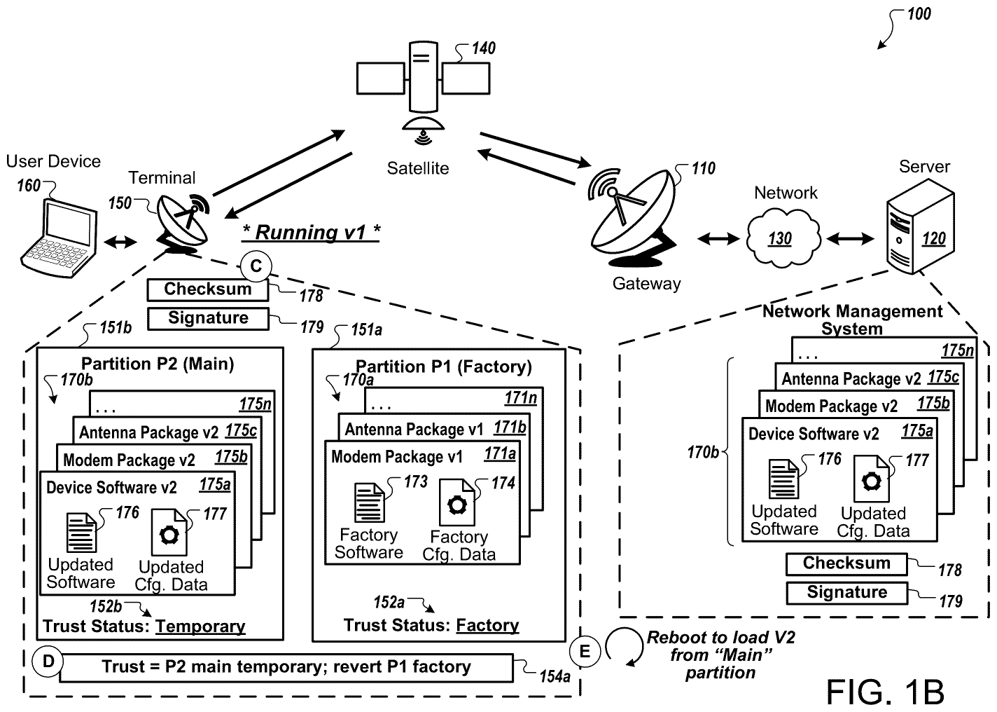

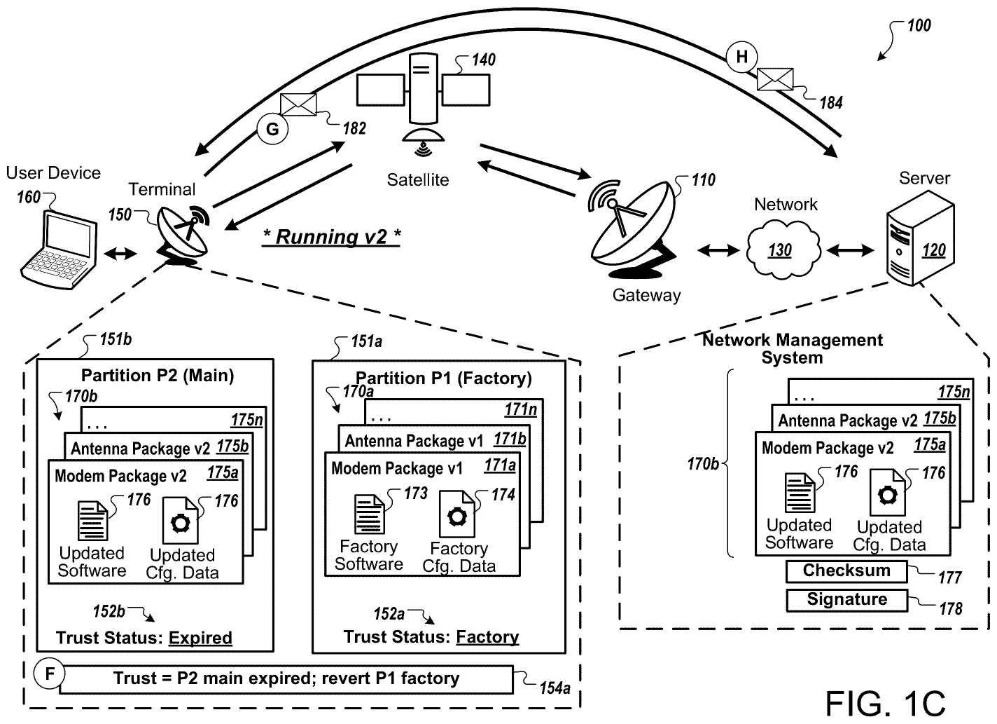

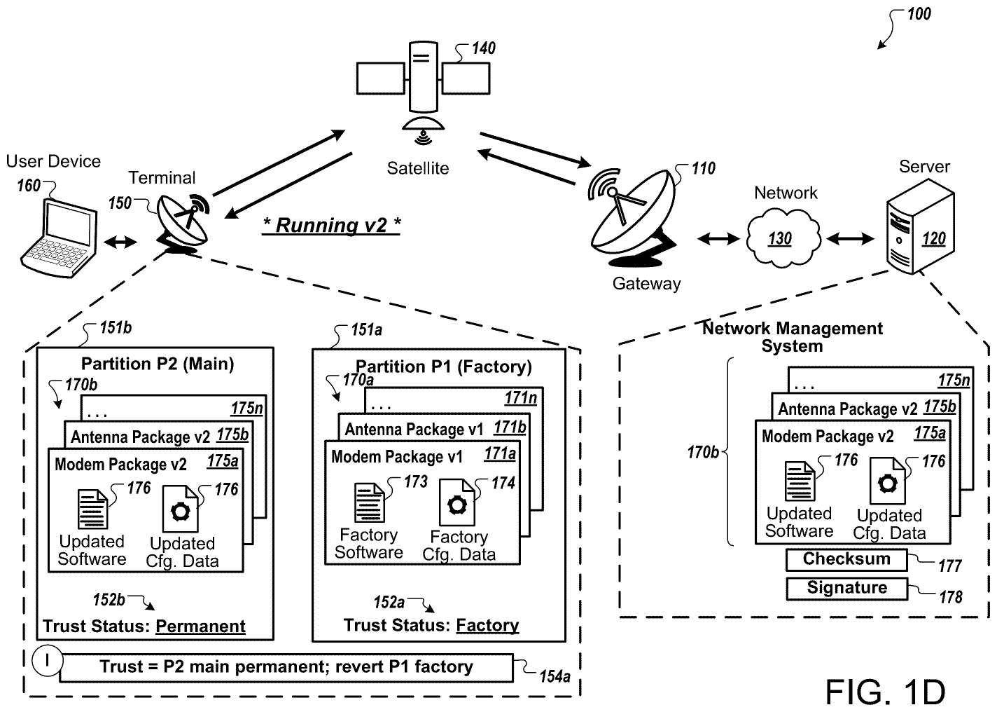

FIGS. 1A-1D are diagrams showing an example of a system 100 for updating software and configuration of a device. The example shows how software for a satellite terminal 150 can be updated, but the same techniques can be used to manage and update many other types of devices (e.g., modem, router, computer, phone, satellite gateway, etc.). In the examples, the terminal 150 starts by running an initial factory version of software and configuration data, then receives updated software (FIG. 1A). The terminal 150 then applies the software update with a limited trust status, e.g., “temporary” trust to allow limited amount of use (FIG. 1B). When the terminal 150 restarts, the new updated software is used but the trust status is downgraded (e.g., to an “expired” state), so continued use of the new software after the next restart requires verification that the terminal 150 operates correctly with the new software (FIG. 1C). Once the verification is performed successfully, and the proper operation of the terminal 150 is confirmed, then the trust in the new software is upgraded (e.g., to “permanent” or high trust) so the software update is used going forward, including after device restarts (FIG. 1D). By contrast, if the terminal 150 does not confirm proper operation after a software update, then the terminal 150 would automatically revert to using the previous working version of the software so proper operation is restored.

The system 100 shows an example of a user device 160 that obtains network connectivity through a satellite connection provided by the satellite terminal 150. The user device 160 is connected to the satellite terminal 150 (e.g., through a local connection), and the terminal 150 communicates with a satellite 140 that is also in communication with a terrestrial satellite gateway 110. The connection from the terminal 150 to the gateway 110 via the satellite 140 provides the network connection to a ground-base network 130, such as the Internet, so the user device 160 can communicate with various other servers and devices.

The system 100 also includes a server 120, which can operate as a network operations center (NOC) or network management system, which can store and provide software updates for satellite terminals or other devices. The terminal 150 can be configured to periodically check for updates through communication with the server 120, and when an update is available, the terminal 150 receives the update over the network connection.

The terminal 150 can be configured to allocate multiple logical data storage areas (such as partitions, file system folders, etc.) for storing different versions of software or other configuration information. This can allow the terminal 150 to preserve multiple versions of software to permit restoration to a factory version in the event of an error, and/or to permit a new software version to be installed and tested without overwriting the previous version of the software.

Managed embedded devices such as satellite terminals, routers, gateways, Internet-of-things (IOT) devices, etc., typically maintain two versions of software and configuration data, such as a “factory” version loaded initially when shipped from the factory, and a “main” version that is the most recent, e.g., the “latest and greatest” version with new features and bug fixes downloaded from the network. Typically, if the user needs to recover the device in the event of a malfunction, the user switches to the factory version by pressing a “rescue” or “reset” button at the back of the device or through a locally executed command. For this reason, since the factory version is often the last ‘lifeline’ the user has in order to restore proper operation, the factory version is often left untouched, e.g., not updated unless absolutely required. Since many devices are often located in remote areas, it becomes very important to not only make sure only compatible software is downloaded and installed, but also provide a recovery mechanism in the event of an upgrade failure. The potential failures go beyond issues such as image corruption (e.g., a corrupted copy of the software being received) and include cases such as interruption of power during the upgrade process or incompatibility or flaw in the upgrade itself preventing the device from becoming operational.

Furthermore, over time, the factory version may become too old and out of date to operate well in combination with other software on the device. As a result, switching to the factory partition may potentially cause problems, such as: (1) a mismatch in configuration, in which the older factory software does not recognize some newer advanced configuration parameters; (2) security loopholes, such as a when a password change in the main partition does not carry over to the factory partition; or (3) incompatibility among versions of component software, such as modem software that is no longer compatible with the older version in the factory partition. The terminal 150 can include features to upgrade software and manage versions based on operational trust, which can be used to reliably recover from operational failures that might occur due to a newly installed software, as well as to reliably upgrade an outdated factory version in the field remotely.

In the example of FIGS. 1A-1D, the terminal 150 has multiple partitions 151a-151b for storing software and configuration data. The first partition “P1” 151a stores a factory version of software, which is labeled as version “v1” of the software. The partition has been designated as a factory version, which typically involves specific certification or qualification by the device manufacturer to reach this status. The factory version is stored and kept available in case the device needs to be recovered or reverted to its factory state.

The terminal 150 has another partition “P2” 151b that is initially empty. The second partition P2 151b is available to store a “main” version of the software, e.g., an upgraded version that will be used to boot the device, but no upgraded version has been received.

The terminal 150 is configured to use trust ratings or trust status indicators to determine which partition 151a-151b to use when booting or starting the terminal 150. For example, if there are multiple versions of software, the terminal 150 can use the trust status indicators to select which version of the software to load and run. In the example, the partition P1 151a has a trust status 152a that indicates high trust, such as the status of “permanent” indicating that the partition P1 151a should be used as the primary version each time the terminal 150 is booted. By contrast, the Partition P2 151b can have a trust status 152b that indicates no trust, such as the status of “expired” or no trust indicator at all, indicating that the partition P2 151b should not be used at all to boot or start the terminal 150. The trust properties for partitions 151a-151b for booting the device can be defined in a set of trust parameters 154a, which indicates that the trust state is “P1 factory,” indicating that the terminal 150 should boot from the P1 partition 151a with the “factory” indication indicating high trust (e.g., permanent, unconstrained, or unlimited) use, allowing for repeated use. Typically, the high level of certification of factory version of the software permits very high trust in factory versions.

The software in the partition can include multiple components. In Linux-based devices, software updates also include updates to the operating system, file system, and device binaries, possibly across multiple storage partitions or mounts. Some devices such as satellite terminals can have multiple components (such as a modem, an antenna, or other subsystems or hardware modules) that each have its own software and configuration settings, in addition to the overall device software (e.g., boot software or operating system). In these cases, a software “bundle” including a software package for each device component, along with the corresponding configuration settings, can be qualified together to make sure the software and settings for the various components function correctly together and are compatible with each other. As a result, it should typically not cause any issues for the device to switch from using one partition to another, as each partition is self-contained with the software and configuration.

In the example, the first version “v1” of the software 170a includes several different software packages 171a-171n. The first package 171a represents overall device software, such as the operating system and other core software components. The package 171a includes the v1 factory software 173 as well as v1 factory configuration data 174. In addition, there are also software packages included for other components or subsystems of the terminal 150. For example, a v1 modem package 171b is included, as well as a v1 antenna package 171c, each of which includes its own set of software and corresponding configuration data.

The terminal 150 can be configured to periodically check with the server 120 to determine whether updated software is available. Alternatively, the server 120 can notify the terminal 150 to check if an update is available. If an updated version is available, then the terminal 150 can receive a copy over the network, test the operation of the new version, and assign an appropriate level of trust if the test of operation is successful. If the test of operation is not successful, the terminal 150 automatically reverts to using a prior version of the software that operates properly. An example of these techniques is shown through FIGS. 1A-1D through a series of operations (A) to (I), which represent a flow of data and various operations performed in the system 100.

In stage (A), the terminal 150 sends a message 180 to the server 120 to request updated software. For example, through interaction with the server 120 over the network, the terminal 150 can determine that a new version of the software is available and can request the new version.

Initially, the terminal 150 is running a factory version 170a of the software. Even after an updated version is received, the factory version 170a is retained. In some implementations, the purpose of the factory version of the software is to ensure that the terminal 150 can establish communication with the server 120 in the Network Management System (NMS) in the Network Operations Center (NOC) and download the main version of the software and configuration.

In stage (B), the terminal receives updated software 170b over the network (e.g., through the network 130 and the satellite communication link over the satellite 140). The updated software 170b includes updated software packages 175a-175n labeled version “v2” for the terminal 150 as a whole (e.g., the operating system, etc.), as well as for various components or subsystems. For example, the updated software 170b includes v2 device software 175a, which includes updated software 176 and updated configuration data 177. Similarly, the v2 modem package 175a, the v2 antenna package 175c, and the other packages can each include different software packages and configuration data. The updated software 170b can include a checksum 178 or hash for verifying correct transmission, as well as a signature 179 to verify authenticity of the update.

Referring to FIG. 1B, in stage (C), the terminal 150, while still running the original v1 software, stores the updated software 170b in the partition P2 151b. When the terminal 150 receives the update software 170b, the terminal 150 can perform a checksum check and a signature check to verify the correctness and authenticity of the new software. While the checksum and signature checks verify the integrity and authenticity of the new software image, the real confirmation that the downloaded software and configuration operates properly is when the device, at the very least, can run the updated software 170b and reestablish contact with the server 120 after the software upgrade.

In stage (D), the trust parameters 154a are set, including a trust status 152b for the partition 151b with the newly-received updated software 170b. To reflect that the updated software 170b has not yet been verified to operate properly, the trust status 152b for the partition P2 151b containing the updated software 170b is set to be a level of low trust, e.g., temporary trust. This indicates that the software in the partition 151b can be run, but subject to one or more limitations. For example, the terminal 150 can be configured to run the software in a partition with temporary trust for a limited number of device starts or for a limited amount of time. In the example, the terminal 150 is configured to run software with a temporary trust level only once based on the temporary trust level. If the operation of the terminal 150 during that one use achieves the criteria for successful operation (e.g., if communication is established with the server 120), then the trust level can be elevated to a high or permanent level, e.g., for repeated or unrestricted use.

In the example, the trust parameters 154a indicate “P2 main temporary; revert P2 factory.” This specifies the order of partitions to boot during the next restart of the terminal 150. After the terminal 150 is restarted, the terminal 150 will boot from the partition P2 151b as the “main” or current version, but will only do so once due to the temporary trust status. If the proper operation of the updated software 170b is not verified before the next restart of the terminal 150, then the terminal 150 will automatically revert to booting from the partition P1 151a, which has a factory designation.

In stage (E), after storing the updated software 170b in the partition P2 151b and setting the trust parameters 154a, the terminal 150 reboots to cause the updated software 170b from the partition P2 151b to be run.

Referring to FIG. 1C, in stage (F), the terminal 150, now having booted using the software 170b in the partition P2 151b (e.g., running version v2), automatically updates the trust parameters 154a to adjust the trust level for the partition P2 151b. The level of trust previously was “temporary,” which allowed one boot. Now that the terminal 150 has booted with the partition P2 151b and the limited single boot has been used, the trust status is updated from “temporary” to “expired” to indicate that the partition P2 151b can no longer be used to boot upon next reboot of the terminal 150. In other words, the limitation on the allowable number of boots for the partition P2 151b has been reached and so further boots will be disallowed, unless the test of operation proves to be successful.

In stage (G), the terminal 150 (while running the v2 update software 170b from the partition P2 151b) tests its operation to verify if it is functioning properly. This can include the terminal 150 attempting to perform a predetermined set of operations and verifying that a predetermined outcome or predetermined criteria for success are achieved. For example, the terminal 150 can be configured to send a request 182 to the server 120 over the network (e.g., the satellite connection and the network 130) to elicit a response from the server 120 that can confirm that the communication functions of the terminal 150 are operating as expected with the new software and configuration.

In the case of the terminal 150, establishing communication over a network is a core or fundamental operation for the terminal 150, and is one that requires most if not all of the subsystems of the terminal 150 to be used and to operate properly. The set of operations attempted or the set of tests performed can be selected to test some or all of the important features (e.g., one or more functions) of a device being updated. In some implementations, the device tests whether operations are completed successfully, and optionally the device tests for performance characteristics also (e.g., throughput, latency, error rates, etc.). The criteria for determining that a device is operating properly or sufficiently well to permit higher trust can be based on not only completing operations or performing functions but on meeting predetermined performance standards also.

In stage (H), the terminal 150 receives a response message 184 from the server 120. The act of receiving the response message 184 in response to the request 182 demonstrates a successfully connection over a network, which indicates that the terminal 150 is operating properly with the updated software 170b in the partition P2 151b. The content of the response message 184 can include various features to show that it is an actual response to the request 182, such as providing values extracted from the request 182, providing a value generated based on the content of the request 182, etc. The terminal 150 examines the response message 184 and determines that the predetermined criteria for judging successful operation has been satisfied. In some implementations, the terminal permits an administrator or operator (whether local or remote) to verify operation and manually indicate the operation as successful. This option can be provided as an alternative route to confirming operation of updated software and configuration data.

In stage (I), the terminal 150 updates the trust parameters 154a to increase the the trust status 152b for the partition P2 151b based on the successful operation of the terminal 150 using the software 170b in the partition P2 151b. For example, because the criteria for successful operation are reached, the terminal 150 increases the trust status from “expired” to “permanent,” which will allow the terminal 150 to boot from the partition P2 151b in subsequent reboots or power cycles of the terminal 150. The resulting trust parameters 154a are “P2 main permanent; revert P1 factory.” This indicates that the partition P2 151b is used as the primary partition to be booted each time.

The example of FIGS. 1A-1D shows a process of updating and testing software by a device in the scenario where the software update is found to be successful. If the software update were unsuccessful, however, the terminal 150 is able to automatically recover from an error or incompatibility arising from installation of an update. For example, in FIG. 1C, after the terminal 150 has downloaded the new software 170b and marked the trust in the main partition P2 151b as “temporary,” the new software 170b is loaded but the trust is immediately marked as “expired,” thereby giving it only one shot to be loaded. In the event that the terminal 150 is unresponsive, not operational, or not functioning properly after the updated software 170b has been loaded, the communication with the server 120 would not be successful and trust would not be upgraded. The customer's typical response to an error or malfunction is to reboot (or power cycle) the terminal 150. Upon reboot, the terminal 150 would recognize that the trust in main partition P2 151b has “expired,” indicating that the stored version is not good, and therefore the terminal 150 loads the alternative version, which is the factory version v1 in this case.

In the example, the trust status for the main software has three different levels or values: (1) permanent, which indicates that the main software is good, and so rebooting the terminal 150 (any number of times) will cause this software to be loaded each time; (2) temporary, which indicates that the main software has not been verified to be good but can still be loaded with one or more limitations (e.g., it is permitted to be loaded once); and (3) expired, which indicates that the main software is not good or has failed, and so the terminal 150 must load an alternative version of the software, such as the factory software.

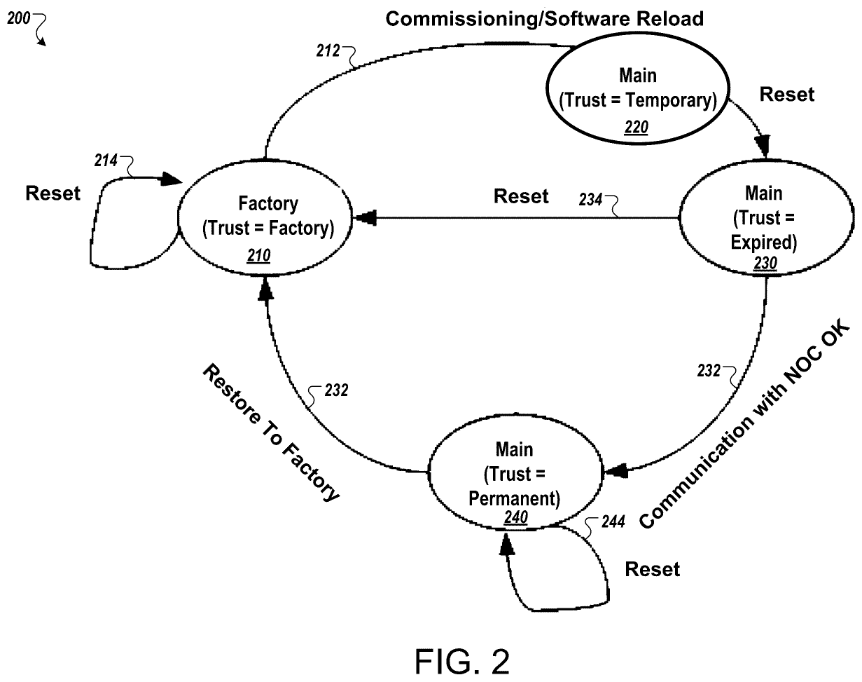

FIG. 2 is a state diagram showing an example of operations of a device for managing software versions and configurations. For example, FIG. 2 shows state transitions based on levels of trust of the main software (e.g., most recent or non-factory version) for a communication device.

In a first state 210, a device runs a factory version of software. When a software update is available, the device can download the updated software to a different partition, as part of commissioning or loading updated software for the device (212). This leads to the second state 220, in which the factory version is still running but the updated software is designated as the main version to use when next booting the device. The main version is assigned a low trust status (e.g., temporary trust) that corresponds to a limitation on use, such as the ability to boot the device only once without verifying proper operation. Loading the new software often includes a reset (e.g., reboot) of the device. In other words, the reset from state 220 to state 230 can be performed automatically by the device, as part of installing or adding the new software.

From the second state 220, resetting the device leads to a third state 230, in which the main version is running, but the allowable number of boots using the main software version has been expended, and so the trust status has been decreased from temporary to expired. In the third state 230, the device runs the main software version, but the “expired” trust status blocks use of the main software again after the device is reset. In the third state 230, the device, while running the updated software in the main partition, attempts to communicate with a network operations center (NOC).

If communication with the server 120 in the NOC is performed successfully (232), then the device moves to a fourth state 240, in which the upgraded software in the main (e.g., non-factory) partition is still designated to be used for booting the device, but the trust status has been increased to remove the previous limitation. For example, the “temporary” trust level has been replaced with a “permanent” trust level that allows unrestricted booting using the upgraded main version of the software. From the fourth state 240, a reset (244) (e.g., reboot or power cycle) of the device will cause the device to boot up again using the same main version of the software.

From the third state 230, if the communication with the NOC is not successful, then the trust status of the main software version is not elevated from the “expired” status. This indicates that the device did not operate properly with the main software version, and so the next time the device is reset (234), the device is returned to the first state 210, in which the factory version is run and the trust levels are set to use the factory version going forward. From the first state 210, if there is a reset (214) without having an additional updated version downloaded, the device will continue to run using the factory version.

In the example of FIG. 2, the trust level for the factory partition in state 210 is listed as “factory.” However, other status levels could be used or set. For example, in some implementations, the trust level can be set to “expired,” indicating that the device should attempt to download a new version, but by virtue of being a factory version (or being in a partition designated for the factory version), booting or loading of the software can be permitted to allow the acquisition of a new version.

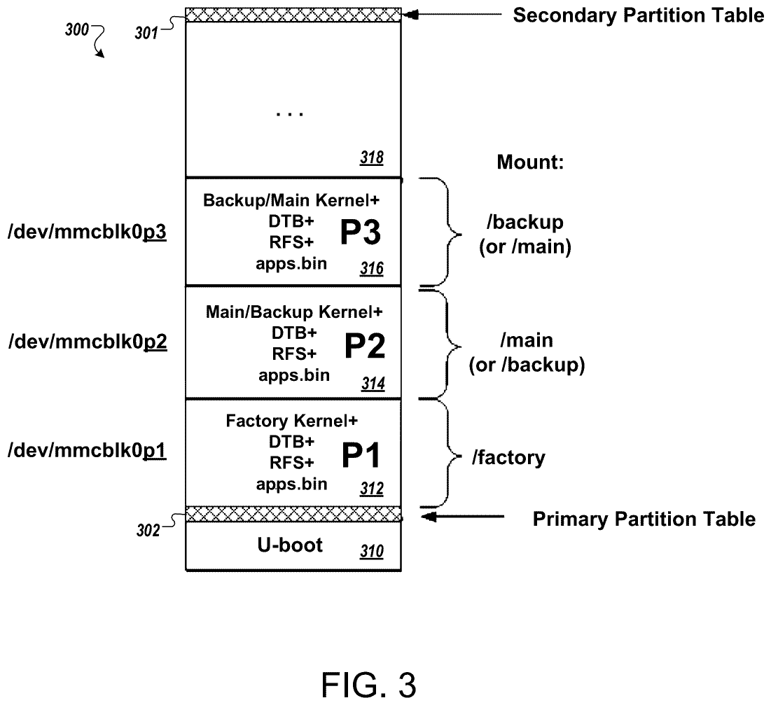

FIG. 3 is a diagram showing an example of a device storage partitions layout for managing software and configurations of a device. The example shows device storage 300 with a primary partition table 302 and a secondary partition table 301. The U-boot partition 310 hosts the device's Linux U-boot firmware along with U-boot environment variables including the information designating the boot priority and trust levels (e.g., a trust flag or other way to specify the trust parameters 154a) for the device.

The primary partition table 302 and the secondary partition table 301 describe storage areas for various partitions that can store software for the device. There are three partitions shown, a first partition P1 312, a second partition P2 314, and a third partition P3 316. Each partition can have a different identifier (e.g., /dev/mmcblk0p1 for the partition P1 312, /dev/mmcblk0p2 for partition P2 314, and /dev/mmcblk0p3 for partition P3 316).

In the example, each partition 312, 314, 316 can have a designated role in the or function, e.g., as the main version of the software (e.g., latest or current version), factory version (e.g., to be used when the device is recovered or reverted to factory settings), and backup version (e.g., a previous main version that operated properly). In the example, the partition P1 (listed as/dev/mmcblk0p1 and mounted as a factory partition “/factory”) contains the factory-shipped software. Once a software update is received, the updated version is stored in the partition P2 (listed as/dev/mmcblk0p2 and mounted as a main partition “/main”). Both the factory version in the partition P1 and the new main version in the partition P2 each include applications software (apps.bin) along with an operating system (e.g., Linux kernel), Device Tree Blob (DTB), and Root File System (RFS), and so on. Including the full set of software needed to run the device in each partition provides a way to easily switch between booting and using one partition rather than another. It also ensures that the set of software and configuration settings in any partition will represent a group of software and settings that is qualified and intended to work together.

If a further update is received (e.g., a second software update), the update can be loaded into the partition P3 316. This means that the partition P3 316 would become the new main version, and the software version in the partition P2 314 would be treated as a “backup,” e.g., the last-known good version, which is more up-to-date than the factory version. If the software in partition P3 316 fails to operate correctly after being downloaded, the new version is discarded and partition P2 314 becomes the main software version again.

If the software in partition P3 316 operates correctly, it remains the main version for the device until the next update (e.g., third update). At this point, the partition P2 314 (which is a backup at the time) can be overwritten with the newest version, and the partition P3 316 becomes the new backup. The device can subsequently alternate between storing new updates in the partition P2 314 and the partition P3 316, each time marking the current main partition as backup and downloading the new version as main to replace the old backup. In the event the trust is not set to permanent for the newly downloaded main version, the device can then revert to using the backup version instead of reverting to the much older factory version.

As an example of the trust flag:
trust=P2 main permanent; revert P1 factory
   This flag indicates to u-boot to load partition P2 as main and in case of errors, load partition P1 as factory.

As another example of the trust flag:
trust=P3 main temporary; revert P2 backup
   This flag indicates to u-boot to load partition P3 as main and in case of errors, load partition P2 as backup. U-boot loads P3 as main but immediately sets the trust as “expired” resulting in the flag to be updated as:
trust=P3 main expired; revert P2 backup
   Since the trust in main has expired, a power cycle or reboot of the device should now cause u-boot to load partition P2 as “backup”.

The trust settings ensure that the device is protected against unexpected power interruptions during and after software upgrades. Since the trust is not modified until the update is complete, the device restarts by booting in the existing partition if reset during the upgrade. On the other hand, if the device is reset post-upgrade before it establishes communication with the NOC/NMS, then the device cannot distinguish between a genuine power interruption versus a power cycle on part of the user to recover the device. In either case, the device reverts to the alternative partition and recovers automatically.

The trust settings can also be used to perform automatic updates to the factory version of the software. The main version's trust can also be used to determine if it can be used to update the outdated factory version, if needed. Typically, not every released main software version is qualified to be a factory version. Factory version replacements are typically provided only when the need arises. Hence, a special identifier such as “_PID” can be added to the software version to indicate to the device that this release has been qualified to be installed as the factory version. The device also performs additional checks listed below before initiating a factory update:
Factory update is enabled (to give control to the NMS); and
The current (main) version is a “_PID” image (to make sure only qualified images are applied for the factory updates); and
The trust in current (main) is permanent (to make sure operational functionality has been verified); and
The current version has been operational for a predetermined period of time (to make sure the current main is operationally stable); and
No other “recovery” actions in progress (to make sure not to conflict with any other recovery processes).

If all of the above criteria are met, then the device automatically sets the trust to load the current partition (P2 or P3) as factory and reboots. For example, the trust can be set as:
trust=P2 factory permanent; revert P3 backup
   Upon reboot, based on the trust in this example, the device loads the software in partition P2 as the factory version. The device, as usual, contacts the server 120 in the NOC and NMS and downloads the (same) software and configuration.

The device recognizes that a factory version update is in progress based on the fact that the factory partition is not the typical partition P1. This determination leads the device to update the P1 partition 312 with the factory version. Upon successful update and reboot, the device reverts to the previous partition (e.g., partition P2 314 or the partition P3 316) as the main version, with the updated software in partition P1 312 designated as the factory version. At this point, the factory partition P1 312 is identical to the main partition P2 314, thereby completing the factory update.

If the automatic approach is not favored, the factory update can be triggered manually as well through an HTTP API. In the factory update process, the “trust” settings ensure that the device is protected against unexpected power interruptions either during or after the factory update. If interruption occurs, the device comes back in the same partition and starts over again.

In general, these techniques provide a system to update and manage devices based on a more comprehensive “operational trust,” which can provide many benefits including a mechanism to define operational trust for the newly downloaded software, a mechanism to automatically use the operational trust to recover from software upgrade failures and power interruptions, and a mechanism to use the operational trust and other criteria to reliably update the factory software in a controlled manner.

A number of implementations have been described. Nevertheless, it will be understood that various modifications may be made without departing from the spirit and scope of the disclosure. For example, various forms of the flows shown above may be used, with steps re-ordered, added, or removed.

Embodiments of the invention and all of the functional operations described in this specification can be implemented in digital electronic circuitry, or in computer software, firmware, or hardware, including the structures disclosed in this specification and their structural equivalents, or in combinations of one or more of them. Embodiments of the invention can be implemented as one or more computer program products, e.g., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

Particular embodiments of the invention have been described. Other embodiments are within the scope of the following claims. For example, the steps recited in the claims can be performed in a different order and still achieve desirable results.

What is claimed is:

1. A method performed by a communication device, the method including:
while operating the communication device using first configuration information stored by the communication device, receiving, by the communication device, updated configuration information;
storing, by the communication device, the updated configuration information while maintaining storage of the first configuration information;
setting, by the communication device, the communication device to operate with the updated configuration information subject to a limitation, wherein the communication device is configured to revert to using the first configuration information instead of the updated configuration information upon occurrence of one or more predetermined conditions; and
after setting the communication device to operate with the updated configuration information subject to the limitation, operating the communication device using the updated configuration information subject to the limitation.

2. The method of claim 1, wherein the updated configuration information comprises at least one of updated software, updated firmware, or updated configuration settings.

3. The method of claim 1, comprising:
after operating the communication device using the updated configuration information subject to the limitation, reverting to operating the communication device using the first configuration information in response to an occurrence of one or more predetermined conditions.

4. The method of claim 1, wherein the communication device is configured to revert to using the first configuration information after a power cycle or restart unless the communication device (i) achieves communication with a remote system that confirms that the communication device operates properly using the updated configuration information or (ii) an operator or administrator indicates that the communication is operating properly using the updated configuration information.

5. The method of claim 1, wherein the limitation comprises a limitation on a number of times the communication device loads the updated configuration information or boots using the updated configuration information.

6. The method of claim 1, wherein setting, by the communication device, the communication device to operate with the updated configuration information subject to the limitation comprises setting a temporary or partial level of trust for the updated configuration information that limits the updated configuration information to be loaded or booted only once without further verification based on information from a remote system over a communication network.

7. The method of claim 1, wherein setting the communication device to operate with the updated configuration information comprises (i) setting a boot variable to specify that updated configuration settings are to be loaded or booted at a next restart or power cycle of the communication device and (ii) specifying a trust status that indicates that the updated configuration settings are used temporarily; and
wherein the method comprises:
after setting the boot variable:
restarting the communication device to load the updated configuration settings or boot the communication device with the updated configuration settings; and
based on the trust status that indicates that the updated configuration settings are used temporarily, (i) setting the boot variable to specify that the first configuration settings are to be loaded or booted at a next restart or power cycle of the communication device, and (ii) altering the trust status such that the updated configuration settings are no longer used.

8. The method of claim 1, wherein setting the communication device to operate with the updated configuration information subject to the limitation comprises designating the updated configuration information to be temporary or untrusted, and adjusting boot settings of the communication device to permit only a single boot of the communication device using the updated configuration information that is temporary or untrusted.

9. The method of claim 1, wherein, when operating the communication device with the updated configuration information subject to the limitation, the communication device is configured to revert to the first configuration information after power loss or restart if the communication device, using the updated configuration information, does not obtain a confirmation from a remote computer system over a communication network.

10. The method of claim 1, wherein the first configuration information comprises a factory-installed version of at least one of software, firmware, or configuration settings for the communication device.

11. The method of claim 1, wherein the first configuration information comprises a previous version of at least one of software, firmware, or configuration settings at least partially received over a communication network.

12. The method of claim 1, wherein the communication device is configured to store multiple versions of configuration information in different partitions, including by storing (i) a factory version of the configuration information in a first partition and (ii) an updated version of the configuration information in a second partition;
wherein receiving the updated configuration information comprises receiving an update that is qualified as an updated factory version of the configuration information; and
wherein the method comprises, after operating the communication device using the updated factory version of the configuration information in a manner that satisfies a set of predetermined criteria, replacing the factory version of the configuration in the first partition with the updated factory version of the configuration information.

13. The method of claim 1, comprising:
while operating the communication device using the updated configuration information, obtaining, by the communication device, confirmation for the updated configuration information through communication of the communication device with a remote computer system over a communication network; and
setting, by the communication device, the communication device to use the updated configuration information without the limitation.

14. The method of claim 1, wherein the communication device is a satellite terminal or a satellite gateway.

15. A communication device comprising:
one or more processors; and
one or more machine-readable media storing instructions that are operable, when executed by the one or more processors, to cause the communication device to perform operations comprising:
while operating using first configuration information stored by the communication device, receiving, by the communication device, updated configuration information;
storing, by the communication device, the updated configuration information while maintaining storage of the first configuration information;
setting, by the communication device, the communication device to operate with the updated configuration information subject to a limitation, wherein the communication device is configured to revert to using the first configuration information instead of the updated configuration information upon occurrence of one or more predetermined conditions; and
after setting the communication device to operate with the updated configuration information subject to the limitation, operating the communication device using the updated configuration information subject to the limitation.

16. The communication device of claim 15, wherein the updated configuration information comprises at least one of updated software, updated firmware, or updated configuration settings.

17. The communication device of claim 15, comprising:
after operating the communication device using the updated configuration information subject to the limitation, reverting to operating the communication device using the first configuration information in response to an occurrence of one or more predetermined conditions.

18. The communication device of claim 15, wherein the communication device is configured to revert to using the first configuration information after a power cycle or restart unless the communication device achieves communication with a remote system that confirms that the communication device operates properly using the updated configuration information.

19. The communication device of claim 15, wherein the limitation comprises a limitation on a number of times the communication device loads the updated configuration information or boots using the updated configuration information.

20. One or more non-transitory machine-readable media storing instructions that are operable, when executed by one or more processors of a communication device, to cause the communication device to perform operations comprising:
operating using first configuration information stored by the communication device;
receiving, by the communication device, updated configuration information;
storing, by the communication device, the updated configuration information while maintaining storage of the first configuration information;
setting, by the communication device, the communication device to operate with the updated configuration information subject to a limitation, wherein the communication device is configured to revert to using the first configuration information instead of the updated configuration information upon occurrence of one or more predetermined conditions; and
after setting the communication device to operate with the updated configuration information subject to the limitation, operating the communication device using the updated configuration information subject to the limitation.
